(19) United States
(12) Patent Application Publication
(10) Pub. No.: US 2015/0109396 A1
(43) Pub. Date: Apr. 23, 2015

(54) RECORDING APPARATUS

(71) Applicant: SEIKO EPSON CORPORATION, Tokyo (JP)

(72) Inventor: Makoto KAWAMOTO, Matsumoto-shi (JP)

(21) Appl. No.: 14/490,151

(22) Filed: Sep. 18, 2014

(30) Foreign Application Priority Data
Oct. 22, 2013 (JP) 2013-218957

(51) Int. Cl. B41J 29/02

(52) U.S. Cl. CPC B41J 29/02
USPC 347/108

(57) ABSTRACT

A recording apparatus includes a housing that has a top wall section on which a top opening is provided, a top opening/closing body that is capable of being disposed at a closing position at which the top opening/closing body covers the top opening, and a recording unit that performs recording on a medium inside the housing. The top opening/closing body disposed at the closing position makes a sliding movement from the closing position, thereby causing the top opening to be exposed.

### BACKGROUND

1. Technical Field

The present invention relates to a recording apparatus, such as a printer.

2. Related Art

An example of a recording apparatus is an ink jet type printer in which ink contained in an ink cartridge is ejected onto a roll of long paper wound in a cylindrical shape and printing is performed. Such printers include a printer in which, in a state where a rotary type opening/closing lid attached to an exterior case is opened, the paper roll is loaded, and the ink cartridge is replaced (for example, see JP-A-2007-152811).

Incidentally, in the above-described printer, in addition to replenishment of supplies, that is, loading of a paper roll or replacement of an ink cartridge, it is necessary to perform maintenance work on the inside of the apparatus. In order to perform the maintenance work on the inside of the apparatus, it is necessary to attach the opening/closing lid to the exterior case as described, and to access the inside of the apparatus.

However, in a case where a printer is disposed in a corner of a room, on a shelf, or the like, the printer is surrounded multilaterally by walls or the like. Thus, there is no space on both sides and at the rear of the printer to open/close an opening/closing lid and to perform the maintenance of the inside of the apparatus.

Such a situation is common not only in the ink jet type printer to perform printing on a paper roll, but also in a recording apparatus that is surrounded multilaterally by walls or the like.

### SUMMARY

An advantage of some aspects of the invention is to provide a recording apparatus in which it is possible to perform maintenance of the inside of the apparatus, even when surrounded multilaterally by walls or the like.

Hereinafter, means of the invention and operation effects thereof will be described.

According to an aspect of the invention, there is provided a recording apparatus including: a housing that has a wall section on which an opening is provided; an opening/closing body that is capable of being disposed at a closing position at which the opening/closing body covers the opening, and a recording unit that performs recording on a medium inside the housing. The opening/closing body disposed at the closing position makes a sliding movement from the closing position, thereby causing the opening to be exposed.

In this configuration, the sliding movement from the closing position of the opening/closing body disposed at the closing position causes the opening to be exposed. Accordingly, it is possible to perform maintenance of the inside of the housing through the opening. Therefore, even in a case where the housing is surrounded multilaterally by walls or the like, and thus there is the only access to the housing from one direction, the sliding movement of the opening/closing body along the direction can cause the opening to be exposed. Accordingly, even when the housing is surrounded multilaterally by the walls or the like, it is possible to perform the maintenance of the inside of the apparatus.

In the recording apparatus, the recording unit may include a liquid ejecting head from which a liquid is ejected onto the medium, and the liquid ejecting head may be attachable/detachable through the opening.

In this configuration, the sliding movement of the opening/closing body makes it possible to perform the attachment/detachment of the liquid ejecting head through the exposed opening. Accordingly, it is possible to perform maintenance of the recording unit through the opening provided on the wall section of the apparatus.

The recording apparatus may further include a ventilation mechanism that performs ventilation of the inside of the housing. The ventilation mechanism may include a duct that is attachable/detachable through the opening.

In this configuration, the sliding movement of the opening/closing body makes it possible to perform attachment/detachment of the duct through the exposed opening. Accordingly, it is possible to perform maintenance of the duct through the opening provided on the wall section.

The recording apparatus may further include a transport mechanism that transports the medium along a transport route. The duct may be disposed on the opening side of the transport route.

In this configuration, detachment of the duct through the opening can cause the transport route of the medium to be exposed. Accordingly, in a case where the transport route is jammed with the medium, it is possible to perform maintenance of the transport route, such as removal of the jammed medium by the detachment of the duct, through the opening.

In the recording apparatus, the opening/closing body may constitute a part of the wall section, when disposed at the closing position.

In this configuration, in a case where the opening/closing body is disposed at the closing position, the opening/closing body constitutes a part of the wall section. Thus, without a great change to the inside configuration of the apparatus in order to secure a space in the housing for accommodating the opening/closing body, it is possible to realize a configuration in which a part of the wall section is opened.

The recording apparatus may further include a cutting mechanism that cuts the medium and produces a cut piece, and a container where the cut piece is contained. The housing may have a side wall section that intersects with the wall section, and the opening/closing body may make the sliding movement from the closing position to the side wall section, thereby causing the opening to be exposed. The opening corresponds to a first opening, and a second opening may be provided on the side wall section, and the container may be detachably mounted at a position where the container covers the second opening of the housing.

In this configuration, when an area for the sliding movement of the opening/closing body is secured at a position which faces the side wall section of the housing, it is possible to perform maintenance of the inside of the housing through the second opening provided on the side wall section, using the area as a working area. That is, even in a case where the recording apparatus is disposed in a confined space surrounded multilaterally by walls or the like, securing of the working area at the position, which faces one side wall section of the housing, makes it possible to perform maintenance of the recording apparatus through the working area. The container can be attached to and detached from the position where the container covers the second opening of the housing. Therefore, in a case where the cut pieces are accumulated in the container, the container is detached from the apparatus, and it is possible to perform maintenance of removal of the accumulated cut pieces.

The recording apparatus may further include a medium holding unit that holds a roll in which the medium is wound in a cylindrical shape in a superposed manner. The medium holding unit may be drawn out from the housing through the second opening after detachment of the container from the housing.

In this configuration, the detachment of the container from the housing makes it possible to draw out the medium holding unit from the housing through the second opening. Thus, since the drawing-out of the medium holding unit from the housing makes it possible to perform maintenance, such as load or replacement of the roll, outside the housing, a good workability is achieved.

In the recording apparatus, the medium holding unit may include a feeding route forming member that forms a feeding route to feed the recording material to the recording unit, a feeding roller pair that feeds the medium along the feeding route, a plate that constitutes a part of the side wall section when accommodated in the housing, and an insertion slit forming portion that forms an insertion slit of the medium between the plate and the insertion slit forming portion. A support that supports the container attached to the housing, a hand-grip portion which is gripped by hand when the medium holding unit is drawn out from the housing, and a notification unit which notifies that the medium is mounted on a position where it is possible for the medium to be fed by the feeding roller pair, may be provided on the plate.

In this configuration, the drawing-out of the medium holding unit from the housing makes it possible to perform maintenance of the feeding route which is provided on the medium holding unit outside the housing. Accordingly, it is possible to easily perform maintenance of the medium holding unit accommodated inside the housing. In addition, since the support that supports the container is provided on the plate of the medium holding unit, it is possible to dispose the plate and the container to be superposed on one side surface side of the housing. The hand-grip portion is provided on the plate of the medium holding unit. Therefore, when the container is detached, the plate can be gripped by hand, and it is possible to draw out the medium holding unit from the housing. In addition, the insertion slit forming portion forms the insertion slit of the medium between the plate and the insertion slit forming portion. Therefore, it is possible to insert the medium into the insertion slit from the one side surface side of the apparatus. Further, the notification unit is provided on the plate of the medium holding unit. Therefore, while visually recognizing the notification unit, it is possible to insert the medium into the insertion slit.

The recording apparatus may further include: a supply mechanism that supplies a recording material to the recording unit; a pair of receptacle mounting portions on each of which a receptacle receiving the recording material is detachably mounted; and a collector mounting portion on which a collector to collect discharged recording material discharged from the recording unit is detachably mounted. On the side wall section, first and second opening/closing portions may be attached to be openable/closable. One receptacle mounting portion and the collector mounting portion may be disposed inside from the first opening/closing portion of the housing, and the other receptacle mounting portion and the supply mechanism may be disposed inside from the second opening/closing portion of the housing.

In this configuration, one receptacle mounting portion and the collector mounting portion are disposed inside from the first opening/closing portion of the housing. Therefore, opening of the first opening/closing portion from one side surface of the apparatus makes it possible to perform the attachment and detachment of the receptacle and of the collector. In addition, the other receptacle mounting portion and the supply mechanism are disposed inside from the second opening/closing portion of the housing. Therefore, opening of the second opening/closing portion from one side surface side of the apparatus makes it possible to perform the attachment and detachment of the receptacle and to perform maintenance of the supply mechanism.

### BRIEF DESCRIPTION OF THE DRAWINGS

The invention will be described with reference to the accompanying drawings, wherein like numbers reference like elements.

FIG. 1 is a perspective view of a recording apparatus according to an embodiment.

FIG. 2 is a top view of the recording apparatus in which a top opening is exposed.

FIG. 3 is a perspective view of a ventilation mechanism.

FIG. 4 is a perspective view of the recording apparatus in which the top opening is exposed.

FIG. 5 is a perspective view of the recording apparatus in which an opening/closing portion is disposed at a opening position.

FIG. 6 is a cross-sectional view of the recording apparatus.

FIG. 7 is a perspective view of the recording apparatus in which a front opening is exposed.

FIG. 8 is a cross-sectional view illustrating a configuration of a feeding mechanism provided in the recording apparatus.

FIG. 9 is a cross-sectional view of the recording apparatus in which a medium holding unit is drawn out.

FIG. 10 is a perspective view illustrating a configuration of the medium holding unit.

### DESCRIPTION OF EXEMPLARY EMBODIMENTS

Hereinafter, embodiments of a recording apparatus will be described with reference to the drawings. The recording apparatus is, for example, a printer in which ink is ejected as an example of a recording material and recording (printing) on a medium is performed.

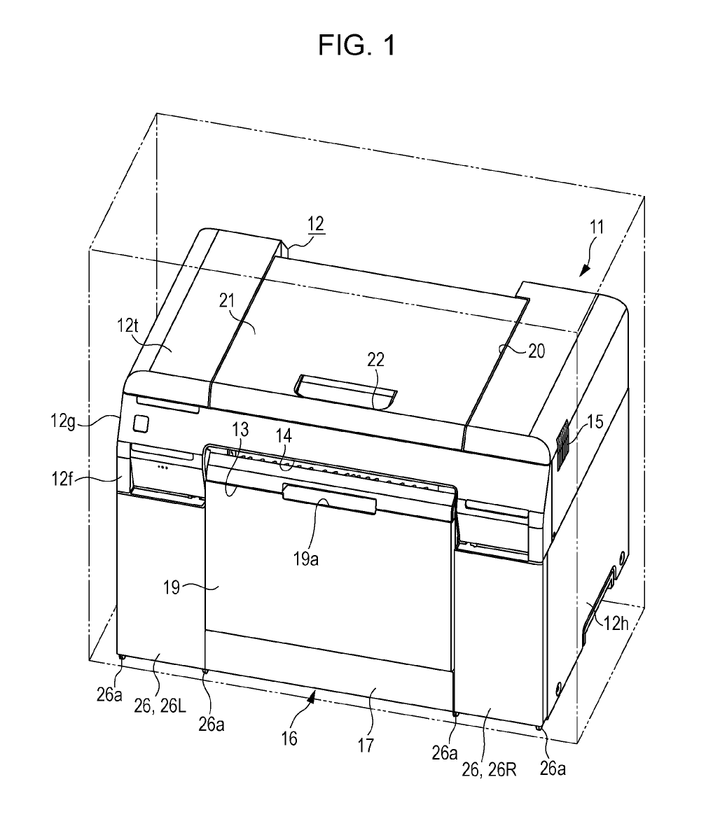

As shown in FIG. 1, a recording apparatus 11 according to an embodiment includes a housing 12 that has a top wall section (wall section) 12t and multiple side wall sections 12f, 12g, and 12h that intersect with the top wall section 12t. According to the embodiment, one of the side wall sections is called the front wall section 12f. Thus, a discharge slit 14 is formed on the front wall section 12f.

A top opening (first opening) 20 is formed on the top wall section 12t of the housing 12. The top wall section 12t is provided with a top opening/closing body (opening/closing body) 21 that is capable of being disposed at a closing position (position shown in FIG. 1) where the top opening/closing body covers the top opening 20. It is preferable that, when the top opening/closing body 21 is disposed at the closing position, the top opening/closing body 21 be a top board that constitutes a part of the top wall section 12t. A handle 22 is provided to be recessed in the top opening/closing body 21.

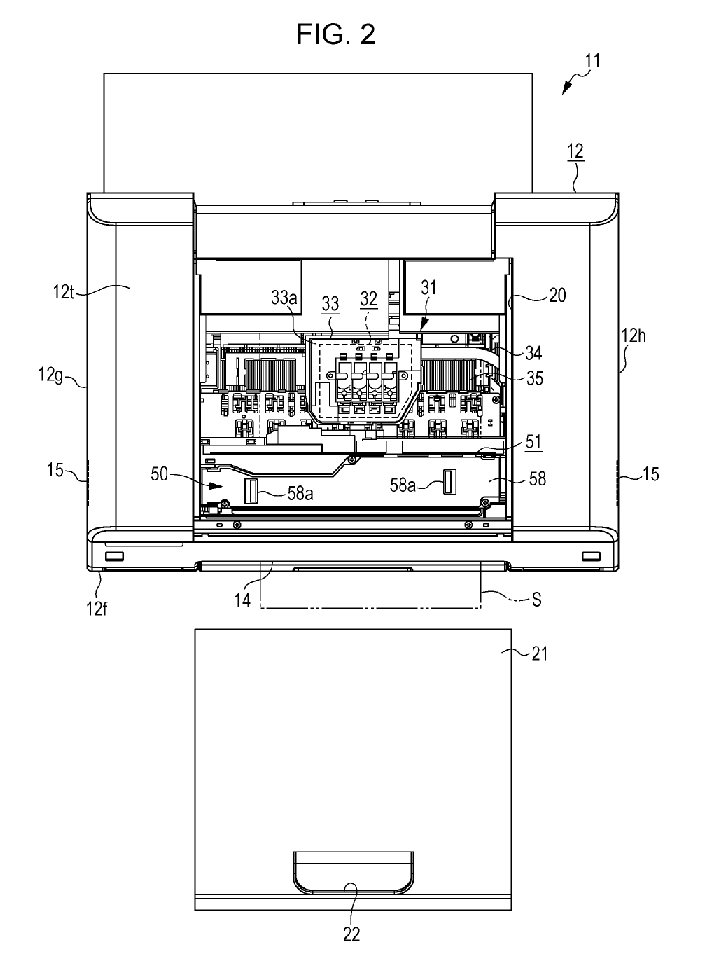

As shown in FIG. 2, when the handle 22 is gripped by hand or the like, and the top opening/closing body 21, which is positioned at the closing position where the top opening/closing body covers the top opening 20, is caused to make a forward sliding movement to the front wall section 12f side, the top opening 20 is exposed. In this case, it is preferable to expose a recording unit 31 that performs recording on a medium S inside the housing 12, and a part of a duct 51 that forms a ventilation mechanism 50 accommodated in the housing 12. Further, a ventilation hole 15 is formed on the side wall sections 12h and 12g of the housing 12, in order to discharge gas that is emitted from the ventilation mechanism 50 to the outside of the housing 12.

The recording unit 31 includes a liquid ejecting head 32 from which ink is ejected onto the medium S, a carriage 33 that holds the liquid ejecting head 32 and reciprocates in a width direction of the medium S (horizontal direction in FIG. 2), and a supply tube 34 to supply the ink to the liquid ejecting head 32. A lid 33a is detachably attached to the top of the carriage 33.

A support member 35, which supports the medium S, is disposed below the movement area of the carriage 33. Since the support member 35 forms a transport route of the medium S, the carriage 33 is caused to make a reciprocating movement on the transport route of the medium S in the width direction. Therefore, when the top opening/closing body 21 is caused to make a forward sliding movement, in addition to the carriage 33, the transport route of the medium S is exposed.

It is preferable that the liquid ejecting head 32 be configured to be detachably mounted on the carriage 33. Then, after the forward sliding movement of the top opening/closing body 21 causes the recording unit 31 to be exposed, detachment of the lid 33a of the carriage 33 makes it possible to attach/detach the liquid ejecting head 32 through the top opening 20. Accordingly, it is possible to perform maintenance, such as cleaning of the detached liquid ejecting head 32 or replacing with a new liquid ejecting head 32, through the top opening 20.

Even when an obstacle, such as a wall, is placed above the recording apparatus 11, the securing of a space between the wall and the top wall section 12t, through which an operator's hand can be passed, makes it possible to perform maintenance, such as replacement of the liquid ejecting head 32, through the space. That is, even when the recording apparatus 11 is disposed in a confined space that is surrounded by walls or the like except for the front of the housing 12, the securing of the working area to the front of the housing 12 makes it possible to perform maintenance of the inside of the housing 12 through the working area.

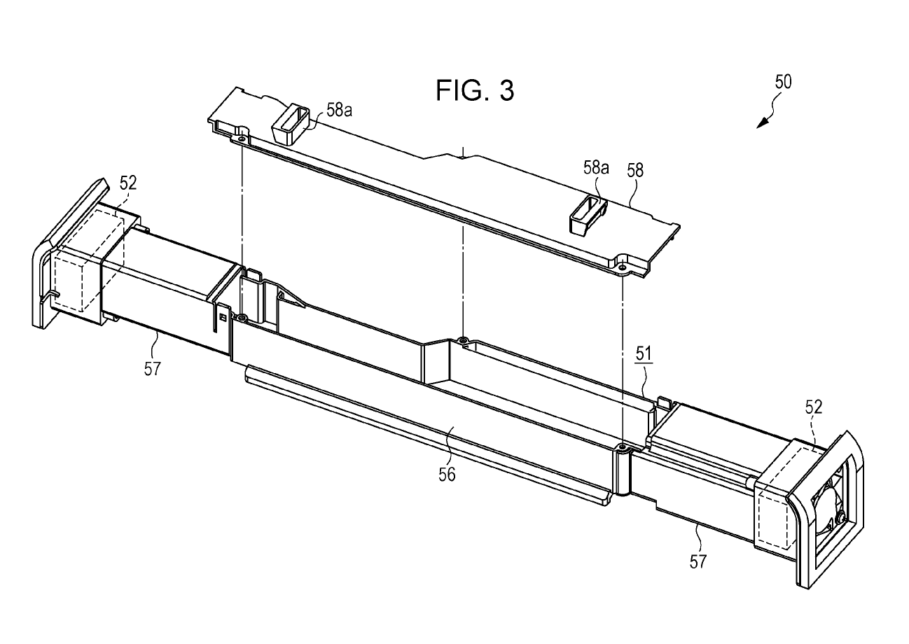

As shown in FIG. 3, the duct 51 includes a suction portion 56 that is disposed at the center in the width direction thereof, a discharge portion 57 that is detachably attached to each of the opposite ends of the suction portion 56 in the longitudinal direction, and a lid member 58 that is attached on the top of the suction portion 56. A pair of grip protrusion portions 58a is provided to protrude from the top surface of the lid member 58. In addition, a fan 52 is accommodated in each of the opposite ends of the duct 51 in the width direction.

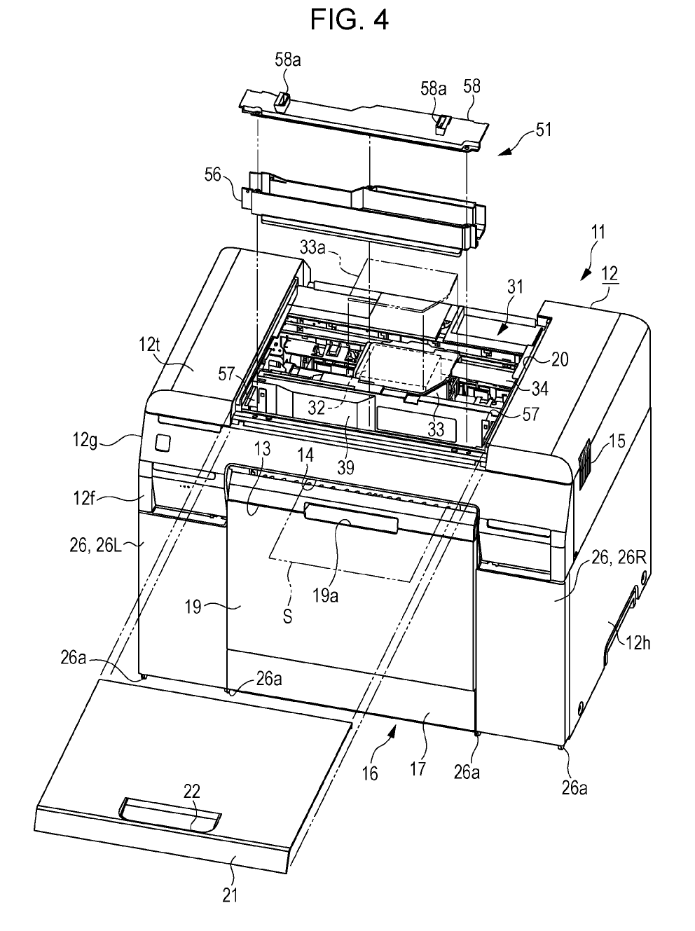

As shown in FIG. 4, it is preferable that the suction portion 56 constituting the duct 51 be configured to be attachable/detachable through the top opening 20. Then, after the forward sliding movement of the top opening/closing body 21 causes the top opening 20 to be exposed, gripping of the grip protrusion portion 58a and the subsequent detachment of the lid member 58 makes it possible to perform maintenance, such as cleaning the duct 51.

Further, it is preferable that the suction portion 56 be disposed above the transport route of the medium S. Then, detachment of the suction portion 56 constituting the duct 51 through the top opening 20 causes the transport route to be exposed. Accordingly, in a case where a medium jam occurs on the transport route, or the like, the suction portion 56 is detached and it is possible to remove the jammed medium S.

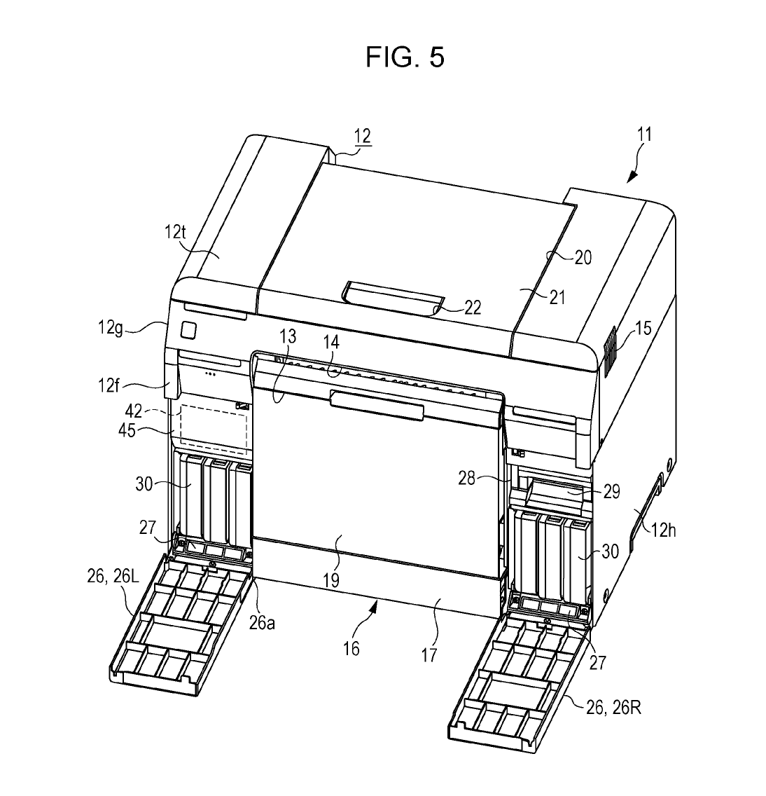

As shown in FIG. 5, it is preferable that a first opening/closing portion 26R be attached to the front wall section 12f to be openable/closable on a first end of the housing 12 in the width direction that intersects with both the front/rear direction and the perpendicular direction, and that a second opening/closing portion 26L be attached to the front wall section 12f to be openable/closable on a second end in the width direction thereof. When the two opening/closing portions 26 rotate about a rotating shaft 26a that is provided on the lower end side, the two opening/closing portions are disposed at an opening position shown in FIG. 5 from a closing position shown in FIG. 1. The first opening/closing portion 26R and the second opening/closing portion 26L are openable/closable independently from each other, and it is possible to open/close the first opening/closing portion 26R alone, or the second opening/closing portion 26L alone, as necessary.

The recording apparatus 11 includes a supply mechanism 42 which supplies ink that is a recording material, a pair of receptacle mounting portions 27, on each of which a receptacle 30 that contains the recording material is detachably mounted, and a collector mounting portion 28 on which a collector 29 is detachably mounted in order to collect a waste liquid that is an unnecessary recording material. Then, it is preferable that one receptacle mounting portion 27 and the collector mounting portion 28 be disposed inside from the first opening/closing portion 26R of the housing 12, and the other receptacle mounting portion 27 and the supply mechanism 42 be disposed inside from the second opening/closing portion 26L of the housing 12.

Then, when the first opening/closing portion 26R is disposed at an opening position, the receptacle mounting portion 27 disposed inside the housing 12 is exposed to make it possible to attach/detach the receptacle 30 and, simultaneously, the collector mounting portion 28 is exposed to make it possible to attach/detach the collector 29. In addition, when the second opening/closing portion 26L is disposed at the opening position, the receptacle mounting portion 27 disposed inside the housing 12 is exposed to make it possible to attach/detach the receptacle 30.

Accordingly, forward opening of the opening/closing portion 26 makes it possible to perform replacement of the receptacle 30 and the collector 29. In addition, in a state where a cover 45 is attached in front of the supply mechanism 42, it is preferable that removing of the cover 45 cause the supply mechanism 42 to be exposed, and thus, it be possible to perform maintenance.

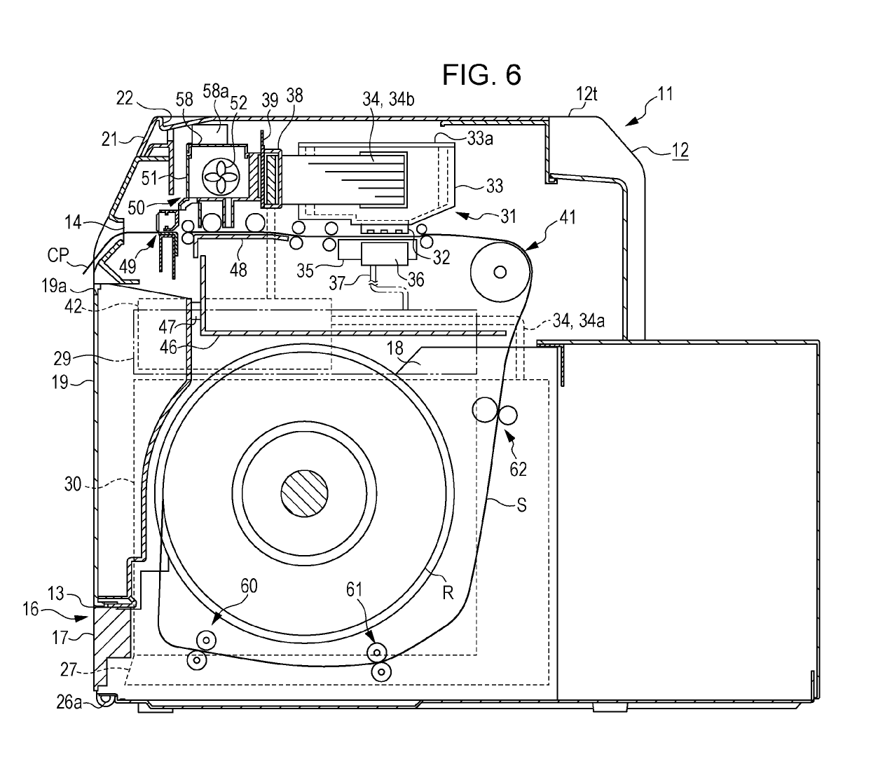

As shown in FIG. 6, the receptacle 30 mounted on the receptacle mounting portion 27 has a longitudinal direction corresponding to the front/rear direction that intersects with the width direction (horizontal direction in FIG. 6). In contrast, a movement area of the carriage 33 and the ventilation mechanism 50 are disposed inside the housing 12 to have a longitudinal direction corresponding to the width direction (the horizontal direction in FIG. 2, and a direction orthogonal to the paper surface in FIG. 6). Then, the receptacle 30 is accommodated not in the same position inside the housing 12 as the position of the movement area of the carriage 33 and the ventilation mechanism 50 in the perpendicular direction, but in a position below the movement area of the carriage 33 and the ventilation mechanism 50 in the perpendicular direction. Therefore, even if ink contained in the receptacle 30 leaks out, there is a small influence on the carriage 33 and the ventilation mechanism 50 that are positioned above the receptacle mounting portion 27.

Three receptacles 30 can be mounted on each receptacle mounting portion 27 according to the embodiment. That is, six receptacles 30 are accommodated inside the housing 12 in total, such that the receptacles are divided by three into two groups to be disposed on each of the opposite ends of the housing 12 in the width direction.

Further, the number of receptacles 30 that are mounted on the receptacle mounting portion 27 is arbitrarily changeable. For example, the number of receptacles 30 that can be mounted on the receptacle mounting portion 27 may be more than 6 or less than 6. In addition, the receptacle mounting portion 27 may be provided on only one end of the housing 12 in the width direction such that all the receptacles are mounted on a single receptacle mounting portion 27 without dividing the multiple receptacles 30 to be disposed on the opposite ends of the housing 12. However, it is preferable that the receptacle mounting portion 27 be provided on each of the opposite ends of the housing 12 in the width direction and that the multiple receptacles 30 be divided and be accommodated in the two receptacle mounting portions 27. This is because the space inside the recording apparatus 11 can be used efficiently, and a good weight balance can be achieved.

Further, the multiple receptacles 30 may respectively contain (be filled with) different types of recording materials (for example, inks), or may contain the same type of recording material. Then, when the multiple receptacles 30 that contain the same type of recording material are mounted on the receptacle mounting portion 27 and no or small amount of recording material remains in one receptacle 30 that supplies the recording material, it is possible to switch the receptacle 30 which supplies the recording material with another receptacle 30 that contains the same type of recording material, and to continue supplying the recording material. Accordingly, when multiple receptacles 30 that contain the same type of recording material are mounted on the recording apparatus 11, and the recording apparatus 11 performs a recording operation, it is possible to replace the one receptacle with an unused receptacle 30 without stopping the recording operation.

Further, even in a state where the number of mounted receptacles 30 is less than the maximum number of receptacles 30 to be mounted on the receptacle mounting portion 27, that is, a state where the receptacle mounting portion 27 has an empty space therein, the recording apparatus 11 may be operated. In this case, it is possible to secure an empty space inside the receptacle mounting portion 27 such that the types of recording materials to be used can be decreased or increased, as necessary.

In addition, a storage element such as an IC chip may be mounted on the receptacle 30, and a terminal that can come into contact with the storage element may be disposed on the receptacle mounting portion 27, such that, in the recording apparatus 11, the residual amount of recording material calculated based on the used amount of recording materials may be stored in the storage element. When the storage element is mounted on the receptacle 30, the storage element may be caused to store information on types or capacity of recording material contained in the receptacle 30. Accordingly, the recording apparatus 11 can determine whether the appropriate receptacles 30 are mounted on the receptacle mounting portion 27, based on the information stored in the storage element.

A suction mechanism 36 that can perform suction of ink from the liquid ejecting head 32 is disposed on an end of the movement area of the carriage 33 in the width direction (direction orthogonal to the paper surface in FIG. 6). The suction mechanism 36 is connected with a waste liquid tube 37 through which the sucked ink from the liquid ejecting head 32 is guided to the collector 29 as a waste liquid. Then, before start of recording or after completion of recording, the suction mechanism 36 performs suction of ink from the liquid ejecting head 32, and then, the sucked ink (waste liquid) is guided to the collector 29 through the waste liquid tube 37.

A partition wall 46 is disposed inside the housing 12 so as to extend in the front/rear direction and the width direction. Then, the recording unit 31 is disposed above the partition wall 46 in the housing 12.

A supply tube 34a that is positioned on the upstream side of the supply tube 34 is routed above the receptacle mounting portion 27 disposed below the partition wall 46 and is connected to the supply mechanism 42. Further, the supply tube 34b that is positioned on the downstream side of the supply tube 34 is routed above the supply mechanism 42, then is routed in the width direction along a frame member 38 fixed in front of the carriage 33, and is connected to the liquid ejecting head 32 accommodated in the carriage 33. A protective frame 39 to protect the supply tube 34b is fixed in front of the supply tube 34b routed in the width direction along the frame member 38.

The supply mechanism 42 is a pump for sending the ink contained in the receptacle 30 to the liquid ejecting head 32. Then, by driving the supply mechanism 42, the ink contained in the receptacle 30 is supplied to the liquid ejecting head 32 through the receptacle mounting portion 27, the supply tube 34a, and the supply tube 34b.

The recording apparatus 11 includes a transport mechanism 41 that transports the medium S along the transport route to the discharge slit 14. The transport mechanism 41 has multiple transport rollers that rotate by a drive force of a drive source not illustrated. Then, when the medium S is transported to the recording unit 31 by the transport mechanism 41, the ink is ejected from the liquid ejecting head 32 onto the medium S, thereby recording (printing) on the medium S being performed.

A heating device 48, which heats the medium S to dry the ink attached on the medium S, is disposed on the downstream side of the recording unit 31 in the transport direction of the medium S. The ventilation mechanism 50 is disposed at a position above the heating device 48, which is a forward position of the protective frame 39. In order to discharge an evaporated solvent component of ink or heated gas inside the housing 12 to the outside of the housing 12, the ventilation mechanism 50 performs ventilation of the transport route where the heating device 48 is disposed.

A cutting mechanism 49 to cut the medium S is provided between the heating device 48 and the discharge slit 14 on the transport route of the medium S. The portion of medium S, on which recording is carried out, is cut by unit length by the cutting mechanism 49, and becomes a cut sheet CP. Further, the cut sheet CP, on which the recording is completed, is discharged outside the housing 12 through the discharge slit 14.

The cutting mechanism 49 performs cutting between the trailing end of a cut sheet CP first cut out from the medium S and the leading end of a cut sheet CP subsequently cut out from the medium S as a margin and produces cut pieces. Then, the cut piece cut by the cutting mechanism 49 is contained in a container 19 that is mounted below the cutting mechanism 49. In addition, a container detecting unit 47 for detecting whether the container 19 is mounted on the housing 12 may be attached on the partition wall 46.

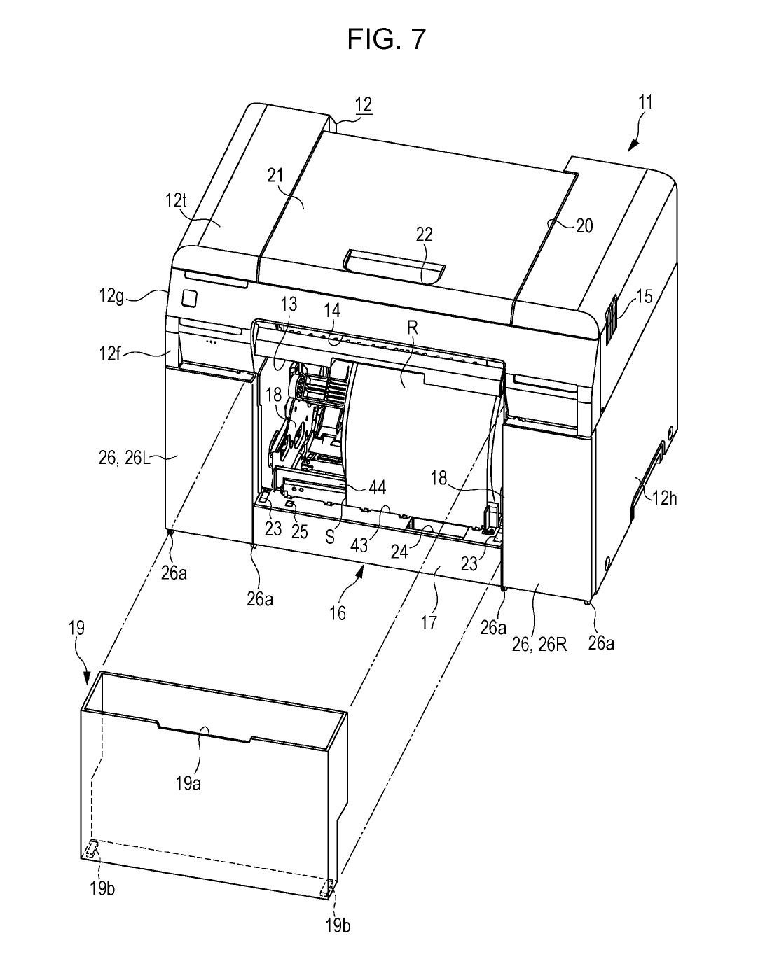

As shown in FIG. 7, a front opening (second opening) 13 is formed on the front wall section 12f that is a side wall section of the housing 12. It is preferable that the container 19 be detachably mounted on a position where the container 19 covers the front opening 13 of the housing 12.

A pair of legs 19b is provided on the opposite ends in the width direction to protrude from the bottom of the container 19. Further, a hand-grip recessed portion 19a is provided on the container 19 to be recessed on the front surface that constitutes a part of the front wall section 12f when the container 19 is attached to the housing 12. Then, in order to remove a cut piece contained in the container 19, the hand-grip recessed portion 19a is gripped by hand, or the like, and the container 19 is detached from the housing 12.

It is preferable that a medium holding unit 16, which holds a roll R in which the medium S is wound in a cylindrical shape in a superposed manner, be accommodated in the housing 12 in a state where the medium holding unit 16 can be drawn out through the front opening 13. Then, when the container 19 is detached from the housing 12, the medium holding unit 16 can be drawn out from the housing 12 through the front opening 13.

The medium holding unit 16 may include a front plate (plate) 17 that constitutes a part of the front wall section 12f in a case of being accommodated in the housing 12, a pair of support walls 18 which is disposed at a position to interpose the mounted roll R therebetween in order to support the roll R, and an insertion slit forming portion 44 that forms an insertion slit 43 of the medium S between the front plate 17 and the insertion slit forming portion. In addition, it is preferable that a support 23 that supports the container 19 attached to the housing 12, a hand-grip portion 24 which is gripped by hand when drawing out the medium holding unit 16 from the housing 12, and a notification unit 25 be provided on the front plate 17 of the medium holding unit 16. Examples of the notification unit 25 include a notification lamp.

When the container 19 is attached to the housing 12, the legs 19b on the container 19 are mounted on the support 23 that is provided to be recessed in the front plate 17. In contrast, when the container 19 is detached from the housing 12, the insertion slit 43, the support 23, the hand-grip portion 24, and the notification unit 25 are exposed.

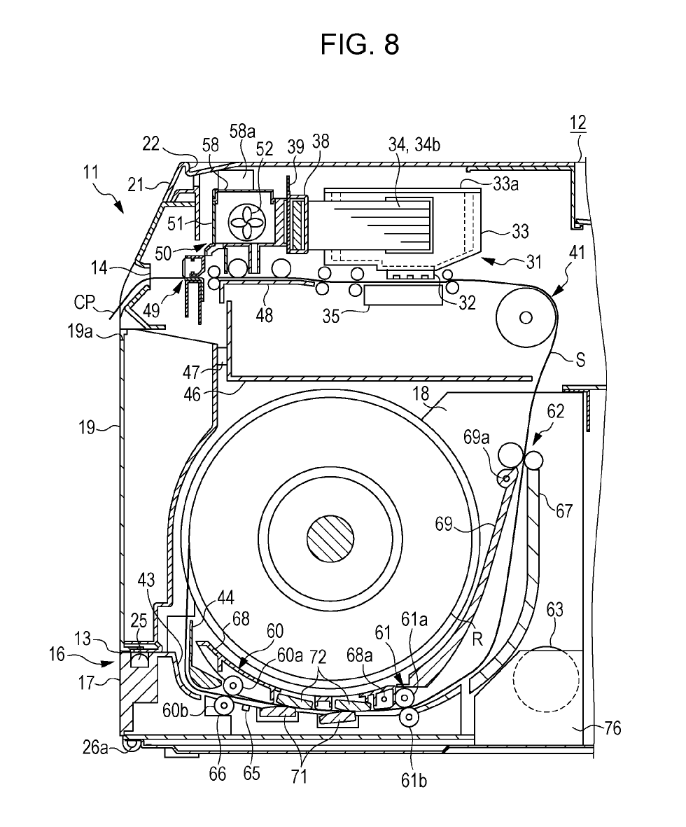

As shown in FIG. 8, the medium holding unit 16 holds a feeding route forming members 66, 67, 68, and 69, which form a feeding route for feeding the medium S to the recording unit 31, and multiple feeding roller pairs 60, 61, and 62, which feed the medium S along the feeding route. The feeding roller pair 60 includes a drive roller 60a and a driven roller 60b, and the feeding roller pair 61 includes a drive roller 61a and a driven roller 61b.

The feeding roller pairs 60, 61, and 62 are supported on the pair of support walls 18 of the medium holding unit 16 which are parallel with each other in the width direction, and are disposed on the inner side between the both support walls 18. The feeding route forming member 66 is fixed at a position below the drive rollers 60a and 61a, the feeding route forming member 67 is fixed by a position on the downstream side of the feeding route forming member 66 in the feed direction of the medium S.

The feeding route forming member 66 holds a medium detecting unit 65 that detects an end of the medium S. The medium detecting unit 65 is disposed on the downstream side in the feed direction of the feeding roller pair 60 that is disposed at the position closest to the insertion slit 43 on the feeding route.

The medium detecting unit 65 is an optical sensor that includes a light emitting portion with a light emitting diode or the like, and a light receiving portion with a photodiode or the like. Then, the medium detecting unit 65 detects the leading end of the medium S based on a change of a light reception state that is caused due to the passing through of the medium S.

When the medium detecting unit 65 detects the leading end of the medium S inserted from the insertion slit 43, the medium detecting unit notifies that the medium S is mounted on a position where the medium S can be fed by the feeding roller pair 60, by changing the state of the notification lamp, that is, the notification unit 25, from a light-off state to a light-on state. Accordingly, since the insertion operation of the medium S is performed while watching the notification unit 25, it is possible to easily confirm that the medium S is appropriately inserted into the position where the automatic transport of the medium S can be performed.

After the medium detecting unit 65 detects the leading end of the medium S inserted from the insertion slit 43, when the container detecting unit 47 detects that the container 19 is mounted on the housing 12, the feeding roller pairs 60, 61, and 62 may feed the medium S to the position where recording can be started.

That is, when the medium holding unit 16 is not accommodated in the housing 12, it is not possible for the container 19 to be attached to the front opening 13. When the medium holding unit 16 is not accommodated in the housing 12, it is not possible for the feeding roller pairs 60, 61, and 62 to start feeding of the medium S. Therefore, when the container detecting unit 47 detects that the container 19 is mounted on the housing 12, it is determined that the medium holding unit 16 is accommodated in the housing 12, and it is possible to start feeding of the medium S.

A cleaner 71 may be detachably attached to the feeding route forming member 66 on the downstream side of the medium detecting unit 65 in the feed direction. Further, a cleaner 72 that constitutes a pair with the cleaner 71 may be detachably attached to the feeding route forming member 68. Then, the cleaners 71 and 72 come into contact with both surfaces of the medium S such that the cleaners gently interpose the medium S fed through the feeding route, and then, dust (paper powder when the medium S is paper) attached to the medium S is removed.

The feeding route forming member 68 may be configured to have a rotating shaft 68a and to be rotatable about the rotating shaft 68a. In addition, the feeding route forming member 69 may be configured to have a rotating shaft 69a and to be rotatable about the rotating shaft 69a.

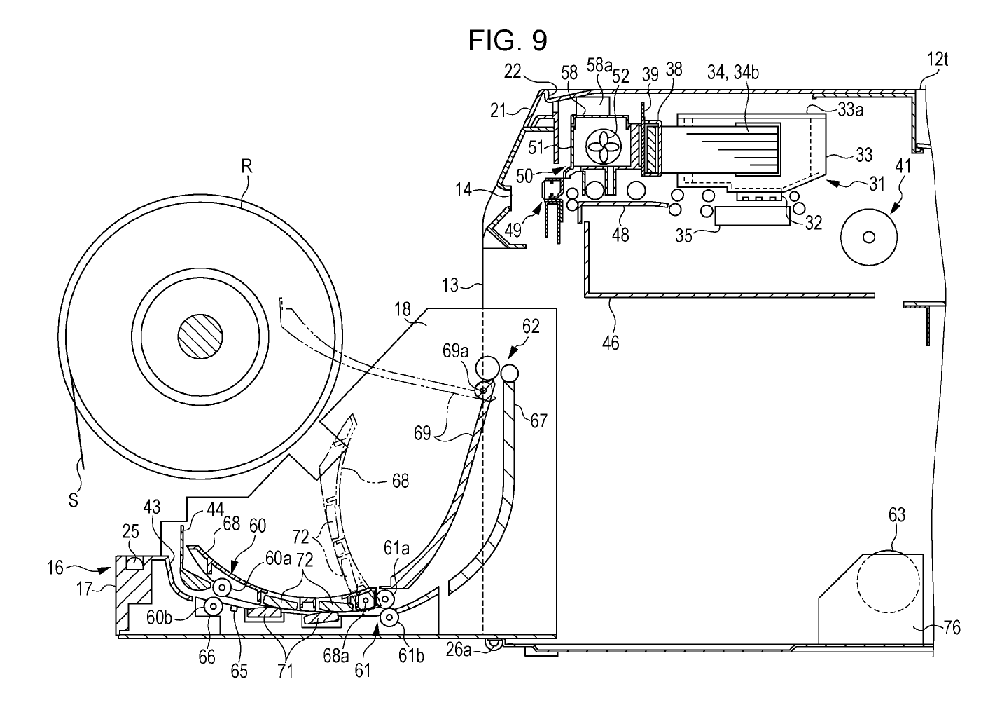

Then, as shown in FIG. 9, after the medium holding unit 16 is drawn out from the housing 12 and the roll R is detached from the medium holding unit 16, rotation of the feeding route forming member 68 about the rotating shaft 68a, as shown by the two-dot chain line in FIG. 9, causes the feeding route to be exposed.

Accordingly, in a case where the feeding route is jammed with the medium S, it is possible to perform maintenance of the feeding route, such as removal of the jammed medium S with the feeding route being exposed, outside the housing 12. Further, since rotation of the feeding route forming member 68 causes the cleaners 71 and 72 to be exposed, it is possible to perform maintenance, such as removal of dirt or paper powder attached to the cleaners 71 and 72, or replacement of the cleaners 71 and 72, outside the housing 12.

Similarly, after the medium holding unit 16 is drawn out from the housing 12 and the roll R is detached from the medium holding unit 16, rotation of the feeding route forming member 69 about the rotating shaft 69a, as shown by the alternate long and two dashes line in FIG. 9, causes the feeding route to be exposed. Therefore, in a case where the feeding route is jammed with the medium S, it is possible to perform maintenance of the feeding route, such as removal of the jammed medium S with the feeding route being exposed, outside the housing 12.

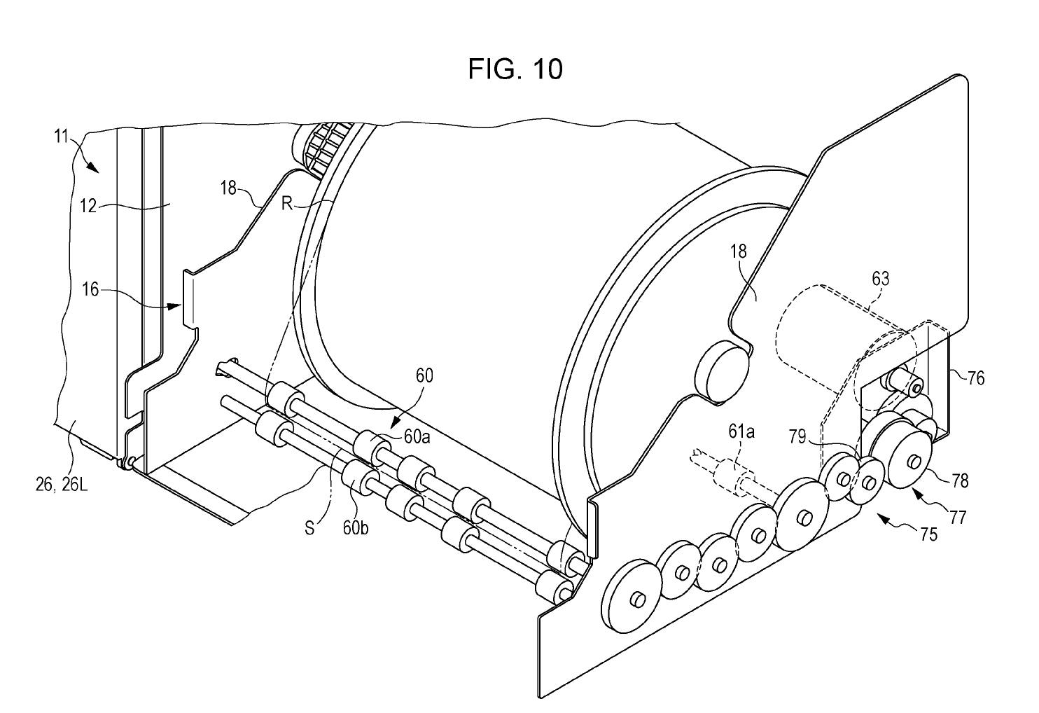

As shown in FIG. 10, a support frame 76 is fixed deep inside a space where the medium holding unit 16 is accommodated in the housing 12. The support frame 76 supports a drive source 63 for rotating the drive rollers 60a and 61a, and a first gear train 77 including gears 78 for transmitting drive force of the drive source 63 to the drive rollers 60a and 61a.

The medium holding unit 16 holds a second gear train 75 including gears 79 that can be engaged with the gear 78. The second gear train 75 is disposed on an outer surface of one support wall 18. Accordingly, when the medium holding unit 16 is accommodated in the housing 12, the engagement of the gear 78 with the gear 79 causes the drive force of the drive source 63 to be transmitted to the drive rollers 60a and 61a.

On the other hand, since, when the medium holding unit 16 is drawn out from the housing 12, the gear 78 and the gear 79 are disengaged, the drive rollers 60a and 61a enter a state of being rotatable. Therefore, when replacing the roll R, or the like, the drawing-out of the medium holding unit 16 from the housing 12 makes it easy to pull the medium S from the insertion slit 43 and take the medium out from the feeding route, or to insert the medium S into the insertion slit 43 and to feed the medium S into the transport route.

Further, since the drawing-out of the medium holding unit 16 from the housing 12 causes the second gear train 75 disposed on the outer surface of the support wall 18 to be exposed, it is possible to perform maintenance, such as cleaning the second gear train 75, outside the housing 12.

Subsequently, operation of the recording apparatus 11 configured as above will be described.

As shown in FIG. 1, when the top wall section 12t, the side wall sections 12g and 12h, and a rear portion of the recording apparatus 11 are surrounded by walls or the like as illustrated with the alternate long and two dashes line in FIG. 1, and there is only a small gap in the top wall section 12t, the only access to the recording apparatus 11 is from the front thereof.

Even in this state, in the recording apparatus 11 according to the embodiment, forward rotation of the opening/closing portion 26 as shown in FIG. 5 makes it possible to perform the replacement of the receptacle 30 and the collector 29 and the maintenance of the supply mechanism 42 from the front of the recording apparatus 11. In addition, the forward detachment of the container 19 as shown in FIG. 7 makes it possible to remove accumulated cut pieces or to replace the roll R, with the medium holding unit 16 drawn out forward.

Further, in a case where the feeding route is jammed with the medium S, the medium holding unit 16 can be drawn out from the housing 12. Then, the rotation of the feeding route forming members 68 and 69 as shown in FIG. 9 causes the feeding route to be exposed. Therefore, it is possible to perform the maintenance of the feeding route, such as removal of the jammed medium S.

Here, when the container 19 is not detached, it is not possible to draw out the medium holding unit 16 from the housing 12. The container 19 according to the embodiment is too slim to stand alone when detached from the housing 12. When the container 19 is detached in order to draw out the medium holding unit 16, the cut pieces accumulated in the container 19 are removed such that the cut pieces are not spilled out. This allows the container 19 to be miniaturized, because the frequent removal of the cut pieces can be performed.

On the other hand, in a case where the recording unit 31 is jammed with the medium S, a hand is put into a gap on the top wall section 12t and is laid on a handle 22, and the forward sliding movement of the top opening/closing body 21 is performed as shown in FIG. 2. Then, since the transport route of the medium S that is a movement area of the carriage 33 is exposed, it is possible to perform the maintenance of the transport route, such as the removal of the jammed medium S.

In addition, as the medium S, on which ink is attached, is dried by the heating device 48, the medium warps, and then, in some cases, the medium is caught by a member of the transport route and causes a medium jam. In this case, the forward sliding movement of the top opening/closing body 21 as shown in FIG. 4 and the subsequent detachment of the suction portion 56 of the duct 51 cause the transport route to be exposed and it is possible to remove the jammed medium S.

Further, the forward sliding movement of the top opening/closing body 21 and the subsequent detachment of the lid 33a on the exposed carriage 33 make it possible to replace the liquid ejecting head 32 from the front of the recording apparatus 11. Furthermore, the forward sliding movement of the top opening/closing body 21 and the subsequent detachment of the lid member 58 of the exposed duct 51 make it possible to perform the maintenance, such as cleaning the duct 51 from the front of the recording apparatus 11.

As described above, in the recording apparatus 11 according to the embodiment, it is possible to perform the replacement of the receptacle 30, the collector 29, or the roll R, or the maintenance of the supply mechanism 42 and the medium holding unit 16 using the space in front of the recording apparatus 11. Further, the forward sliding movement of the top opening/closing body 21 causes the top opening 20 to be exposed and it is possible for a hand to make a reach into the upper gap on the recording apparatus 11, thereby performing maintenance of the inside of the housing 12.

According to the above embodiment, the achievable effects are as follows.

(1) The sliding movement from the closing position of the top opening/closing body 21 disposed at the closing position causes the top opening 20 provided on the top wall section 12t to be exposed. Accordingly, it is possible to perform the maintenance of the inside of the housing 12 through the top opening 20. Therefore, even in a case where the housing 12 is surrounded multilaterally by walls or the like, and thus, there is the only access to the housing 12 from one direction, the sliding movement of the top opening/closing body 21 along the direction causes the top opening 20 to be exposed. Accordingly, even in a case where the recording apparatus is surrounded multilaterally by walls or the like, it is possible to perform the maintenance of the inside of the recording apparatus 11.

(2) The forward sliding movement of the top opening/closing body 21 makes it possible to perform the attachment or detachment of the liquid ejecting head 32 through the exposed top opening 20. Accordingly, it is possible to perform the maintenance of the recording unit 31 through the top opening 20 provided on the top wall section 12t.

(3) The sliding movement of the top opening/closing body 21 makes it possible to perform the attachment/detachment of the suction portion 56, which constitutes the duct 51, through the exposed top opening 20. Accordingly, it is possible to perform the maintenance of the duct 51 through the top opening 20 provided on the top wall section 12t of the recording apparatus 11.

(4) The detachment of the suction portion 56, which constitutes the duct 51, through the top opening 20 causes the transport route of the medium S to be exposed. Accordingly, in a case where the transport route is jammed with the medium S, it is possible to perform the maintenance of the transport route, such as removal of the jammed medium S by the detachment of the suction portion 56, through the top opening 20.

(5) In a case where the top opening/closing body 21 is disposed at the closing position, the top opening/closing body 21 constitutes a part of the top wall section 12t. Therefore, without a great change to the inside configuration of the recording apparatus 11 in order to secure a space in the housing 12 for accommodating the top opening/closing body 21, it is possible to realize a configuration in which the part of the top wall section 12t is opened.

(6) When the area for the sliding movement of the top opening/closing body 21 is secured at a position which faces the front wall section 12f which is the side wall section of the housing 12, it is possible to perform the maintenance of the inside of the housing 12 through the front opening 13 provided on the front wall section 12f using the area as the working area. That is, even in a case where the recording apparatus 11 is disposed in a confined space surrounded multilaterally by walls or the like, the securing of the working area at the position, which faces the front wall section 12f of the housing 12, makes it possible to perform the maintenance of the recording apparatus 11 through the working area.

(7) The container 19 can be attached to and detached from the position where the container covers the front opening 13 of the housing 12. Therefore, in a case where the cut pieces are accumulated in the container 19, the container 19 is detached from the recording apparatus 11 and it is possible to perform the maintenance of removal of the accumulated cut pieces.

(8) The detachment of the container 19 from the housing 12 makes it possible to draw out the medium holding unit 16 from the housing 12 through the front opening 13. Then, since the drawing-out of the medium holding unit 16 from the housing 12 makes it possible to perform the maintenance, such as the load or replacement of the roll R, outside the housing 12, a good workability is achieved.

(9) The drawing-out of the medium holding unit 16 from the housing 12 makes it possible to perform the maintenance of the feeding route, which is provided on the medium holding unit 16, outside the housing 12. Accordingly, it is possible to easily perform the maintenance of the medium holding unit 16 accommodated in the housing 12.

(10) Since the support 23 that supports the container 19 is provided on the front plate 17 of the medium holding unit 16, it is possible to dispose the front plate 17 and the container 19 to be superposed on the front surface of the housing 12.

(11) The hand-grip portion 24 is provided on the front plate 17 of the medium holding unit 16. Therefore, when the container 19 is detached, the front plate 17 is gripped by hand from the front of the recording apparatus 11, and it is possible to draw out the medium holding unit 16 from the housing 12.

(12) The insertion slit forming portion 44 forms the insertion slit 43 of the medium S between the front plate 17 and the insertion slit forming portion 44. Therefore, it is possible to insert the medium S into the insertion slit 43 from one side surface side of the recording apparatus 11.

(13) The notification unit 25 is provided on the front plate 17 of the medium holding unit 16. Therefore, while visually recognizing the notification unit 25, it is possible to insert the medium S into the insertion slit 43.

(14) One receptacle mounting portion 27 and the collector mounting portion 28 are disposed inside from the first opening/closing portion 26R of the housing 12. Therefore, the opening of the first opening/closing portion 26R from the one side surface side of the recording apparatus 11 makes it possible to perform the attachment and detachment of the receptacle 30 and the collector 29. In addition, the other receptacle mounting portion 27 and the supply mechanism 42 are disposed inside from the second opening/closing portion 26L of the housing 12. Therefore, the opening of the second opening/closing portion 26L from the one side surface side of the recording apparatus 11 makes it possible to perform the attachment and detachment of the receptacle 30, and to perform the maintenance of the supply mechanism 42.

Further, the above embodiment may be modified as follows.
According to the above embodiment, the first opening and the second opening are described as the top opening 20 and the front opening 13, respectively. However, the positions may be changed in the vertical direction along the perpendicular direction, in the horizontal direction as the width direction, and in the front/rear direction. That is, the first opening may be provided on a wall section of the housing 12 other than the top wall section 12t, and an opening/closing body may be provided to make a sliding movement from the closing position, where the opening/closing body covers the first opening, in a direction other than the forward direction. In addition, the second opening may be provided on a wall section other than the front wall section 12f. Further, multiple wall sections may be provided, on which an opening is provided to be blocked by the opening/closing body which makes a sliding movement. For example, when, in addition to the top wall section 12t, an opening is provided on the side wall sections 12g and 12h, or the like, and the opening is blocked using the opening/closing body which makes a forward sliding movement, it is possible to gain access to multiple places, such as the top or the side of the housing 12, from the working area secured in front of the housing 12 and thus to perform the maintenance of the inside of the housing 12.
A configuration may be employed, in which the receptacle 30 is detachably mounted on the carriage 33 that holds the liquid ejecting head 32. In this configuration, the attachment and detachment of the receptacle 30 can be performed through the top opening 20. In this case, the supply tube 34 may not be provided, and since the receptacle mounting portion 27 and the supply mechanism 42 may not be provided inside from the second opening/closing portion 26L of the housing, the second opening/closing portion 26L may not be provided.
A configuration may be employed, in which the collector 29 is attached/detached through the top opening 20. In this configuration, the first opening/closing portion 26R may not be provided.
A configuration may be employed, in which the entire duct 51 is attached/detached through the top opening 20.

A configuration may be employed, in which the recording apparatus 11 performs recording on a cut sheet cut off in a predetermined length. In this case, a configuration can be employed, in which a cassette that is capable of containing multiple cut sheets can be drawn out through the front opening provided on the front wall section 12f. In a case of employing this configuration, the cutting mechanism 49 and the container 19 may not be provided.

In addition, a configuration may be employed, in which the container 19 is attached/detached through the top opening 20.

As above, in a case where it is not necessary to attach/detach the container 19 to the front wall section 12f, it is possible to employ a configuration in which, the opening/closing body that rotates about the rotating shaft provided on the lower end is attached to the front wall section 12f, and when the opening/closing body rotates forward, the medium holding unit provided on the rear surface side of the opening/closing body is exposed.
It is possible to employ a configuration in which the rotating shaft 26a is provided on the upper end of the opening/closing portion 26 and the lower end of the opening/closing portion 26 rotates forward, and it is possible to employ a configuration in which the rotating shaft 26a is provided on the side end of the opening/closing portion 26 and the opening/closing portion 26 is horizontally-opened.
A configuration may be employed in which the top opening/closing body 21 integrally holds members, such as the transport route forming member that forms the transport route of the medium S or the lid member 58 of the duct 51. In this case, upon detaching the top opening/closing body 21 from the top wall section 12t, it is possible to expose the transport route of the medium S, or to expose the inside of the duct 51.
The ventilation mechanism 50 may discharge ink mist produced due to the ejecting of ink, or may discharge gas in order to cool the devices inside the housing 12.

In a case where the ventilation mechanism 50 discharges the ink mist or the solvent component of the ink, the recording apparatus 11 can be an ink jet type printer in which a liquid, such as ink, is ejected and recording is performed. In this case, the recording apparatus 11 may be changed to a so-called full-line type recording apparatus in which the recording unit 31 does not include the carriage 33, but includes a fixed long recording head corresponding to the entire width of the medium S. The recording head in this case may have a recording range across the entire width of the medium S, with multiple unit head sections, on which nozzles are formed, in a parallel arrangement, or with a single long head, on which many nozzles are arranged such that the recording range is across the entire width of the medium S.

The recording material used in recording may be a fluid (including a liquid, a liquid-phase substance in which particles of a functional material are dispersed or mixed in a liquid, a fluid-phase substance, such as a gel, or a solid that can flow and be ejected as a fluid) other than ink. For example, a configuration may be employed, in which recording is performed by ejecting a liquid-phase substance including materials, such as an electrode material or a color material (pixel materials) used in manufacturing a liquid crystal display, an electroluminescence (EL) display, and a surface emitting display, in a dispersing or dissolving manner.

That is, the recording apparatus, in which the fluid is ejected and recording is performed, may be a fluid-phase substance ejecting apparatus in which a fluid-phase substance, such as a gel (for example, a physical gel), is ejected, or a powdery and granular substance ejection apparatus (for example, toner jet type recording apparatus) in which a solid including a powdery substance (powdery and granular substance), such as toner, is ejected. The “fluid” in this specification does not include a fluid consisting of only gases, but includes a liquid (including an inorganic solvent, an organic solvent, a solution, a liquid resin, a liquid metal (metallic melt), or the like), a liquid-phase substance, a fluid-phase substance, a powdery and granular substance (including granules and powder), or the like.

Meanwhile, in a case where the ventilation mechanism 50 performs the ventilation on a purpose of cooling, the recording apparatus provided with the ventilation mechanism 50 is not limited to the ink jet type printer in which the fluid is ejected and recording is performed. For example, the recording apparatus may be a non-impact printer, such as a laser printer, an LED printer, or a thermal-transfer printer (including a sublimation printer), or an impact printer, such as a dot impact printer.

In addition, the recording apparatus is not limited to a printer that includes a printing function alone, but may be a multifunction printer with an image reading function, or may be a facsimile, a copy machine, or a multifunction printer including those machines.
The medium S is not limited to a sheet, but may be a plastic film or a thin plate material, or may be a fabric that is used in a fabric printing apparatus or the like.

The entire disclosure of Japanese Patent Application No. 2013-218957, filed Oct. 22, 2013 is expressly incorporated by reference herein.

What is claimed is:

1. A recording apparatus comprising:
a housing that has a wall section on which an opening is provided;
an opening/closing body that is capable of being disposed at a closing position at which the opening/closing body covers the opening; and
a recording unit that performs recording on a medium inside the housing,
wherein the opening/closing body disposed at the closing position makes a sliding movement from the closing position, thereby causing the opening to be exposed.

2. The recording apparatus according to claim 1,
wherein the recording unit includes a liquid ejecting head from which a liquid is ejected onto the medium, and
the liquid ejecting head is attachable/detachable through the opening.

3. The recording apparatus according to claim 1, further comprising:
a ventilation mechanism that performs ventilation of the inside of the housing,
wherein the ventilation mechanism includes a duct that is attachable/detachable through the opening.

4. The recording apparatus according to claim 3, further comprising:
a transport mechanism that transports the medium along a transport route,
wherein the duct is disposed on the opening side of the transport route.

5. The recording apparatus according to claim 1,
wherein the opening/closing body constitutes a part of the wall section, when disposed at the closing position.

6. The recording apparatus according to claim 1, further comprising:
a cutting mechanism that cuts the medium and produces a cut piece; and
a container where the cut piece is contained,
wherein the housing has a side wall section that intersects with the wall section,
the opening/closing body makes a sliding movement from the closing position to the side wall section, thereby causing the opening to be exposed,
the opening corresponds to a first opening, and a second opening is provided on the side wall section, and
the container is detachably mounted on a position where the container covers the second opening on the housing.

7. The recording apparatus according to claim 6, further comprising:
a medium holding unit that holds a roll in which the medium is wound in a cylindrical shape in a superposed manner,
wherein the medium holding unit is drawn from the housing through the second opening after detachment of the container from the housing.

8. The recording apparatus according to claim 7,
wherein the medium holding unit includes a feeding route forming member that forms a feeding route to feed the medium to the recording unit, a feeding roller pair that feeds the medium along the feeding route, a plate that constitutes a part of the side wall section when accommodated in the housing, and an insertion slit forming portion that forms an insertion slit of the medium between the plate and the insertion slit forming portion, and
a support that supports the container attached to the housing, a hand-grip portion that is gripped by hand when the medium holding unit is drawn out from the housing, and a notification unit which notifies that the medium is mounted on a position where it is possible for the medium to be fed by the feeding roller pair, are provided on the plate.

9. The recording apparatus according to claim 6, further comprising:
a supply mechanism that supplies a recording material to the recording unit;
a pair of receptacle mounting portions on each of which a receptacle receiving the recording material is detachably mounted; and
a collector mounting portion on which a collector to collect a recording material discharged from the recording unit is detachably mounted,
wherein, on the side wall section, first and second opening/closing portions are attached to be openable/closable, and
one receptacle mounting portion and the collector mounting portion are disposed inside from the first opening/closing portion of the housing, and the other receptacle mounting portion and the supply mechanism are disposed inside from the second opening/closing portion of the housing.
